(19) United States
(12) Patent Application Publication
(10) Pub. No.: US 2013/0314482 A1
(43) Pub. Date: Nov. 28, 2013

(54) PSEUDO-PRESSURE-SENSITIVE ADHESIVE COMPOSITION AND PRESSURE-SENSITIVE ADHESIVE SHEET

(71) Applicant: RISO KAGAKU CORPORATION, Tokyo (JP)

(72) Inventors: Jun OZAKI, Ibaraki-ken (JP); Kokoro KINOE, Ibaraki-ken (JP); Hiroshi HAYASHI, Ibaraki-ken (JP); Tsutomu NIO, Ibaraki-ken (JP); Kazuhiro HIGASHI, Ibaraki-ken (JP)

(73) Assignee: RISO KAGAKU CORPORATION, Tokyo (JP)

(21) Appl. No.: 13/867,592

(22) Filed: Apr. 22, 2013

(30) Foreign Application Priority Data
May 25, 2012 (JP) 2012-119343

(51) Int. Cl. C09J 7/02

(52) U.S. Cl. CPC C09J 7/0214
USPC 347/101; 428/355 AK; 524/521

(57) ABSTRACT

A pseudo-pressure-sensitive adhesive composition is provided, wherein the pseudo-pressure-sensitive adhesive composition comprises an adhesive base, a filler and a polymer, wherein the polymer is a polyallylamine and/or a polydiallyldimethylammonium chloride with a weight-average molecular weight of less than 100,000.

### CROSS REFERENCE TO RELATED APPLICATIONS

This application is based upon and claims the benefit of priority from prior Japanese Patent Applications No. 2012-119343 filed on May 25, 2012, the entire contents of which are incorporated by reference herein.

### BACKGROUND OF THE INVENTION

1. Field of the Invention

The present invention relates to a pseudo-pressure-sensitive adhesive composition, a pressure-sensitive adhesive sheet, and a printing method.

2. Description of the Related Art

Compared with typical postcards, pressure-bonded postcards provide a larger information recording surface, meaning more information can be included, and because the information recording surface is pressure-bonded, confidentiality can be ensured. Moreover, being a postcard, transport costs such as the postage can be reduced compared with normal sealed letters. Accordingly, pressure-bonded postcards are used for sending highly confidential information such as personal information, and also for direct mail and the like.

In pressure-bonded postcards, a pressure-sensitive adhesive sheet to which a pseudo-pressure-sensitive adhesive composition has been applied is used. In this type of pressure-sensitive adhesive sheet, printing is performed on the surface coated with the pseudo-pressure-sensitive adhesive composition, and the sheet is folded with this coated surface facing inward and then bonded under pressure. Subsequently, the bonded surfaces are peeled apart to enable the printed surface to be viewed.

Conventionally, pseudo-pressure-sensitive adhesive compositions containing a natural rubber latex, a modified product thereof, a synthetic rubber latex or a synthetic resin or the like have been used for pressure-sensitive adhesive sheets that can be printed using an offset printing apparatus or an electrographic printer or the like. In recent years, inkjet printing devices have become very widespread, and it would be ideal if printing using an inkjet printing method could also be performed on pressure-sensitive adhesive sheets coated with pseudo-pressure-sensitive adhesive compositions. In inkjet printing methods, the use of non-aqueous inks containing mainly non-volatile solvents is desirable, as such inks yield superior water resistance of the recording medium, and are more resistant to nozzle blockages.

However, if the fixability of the ink during printing to the pressure-sensitive adhesive sheet is inadequate, then ink transfer to the surface opposing the printed surface becomes a problem when the pressure-bonded postcard is peeled open. Further, if the adhesive base in the pseudo-pressure-sensitive adhesive composition is able to react with the polymer to produce an aggregate, then the stability of the composition deteriorates, and the applicability of the composition onto the sheet base material also deteriorates.

Patent Document 1 proposes a pressure bonding paper for use with an inkjet which exhibits excellent ink coloration when printing is performed on the confidential surface of the paper using an inkjet printer, has good water resistance, and does not suffer from transfer of the printing on the confidential surface to the opposing surface when the confidential surface is pressure-bonded and then peeled open, wherein the pressure bonding paper is coated with an adhesive composition comprising a cationic polymer for which the electrical charge changes to a value within a range from zero to a negative value under conditions of high pH, and a cationic polymer that retains a positive electrical charge. In Examples 5 and 8 of Patent Document 1, an adhesive composition comprising a combination of N-hydroxypropyl polyethyleneimine and polyallylamine hydrochloride is used.

Patent Document 2 proposes a pressure bonding paper for use with inkjet recording having a layer of a pseudo-adhesive containing a fine particulate filler having specific physical properties and a cationic resin formed on the paper, with the aim of improving the absorption, drying properties, fixability and non-transferability of inkjet dyes on the pressure bonding paper.

Patent Document 2 targets the use of aqueous inks, and proposes that by including the cationic resin within the pseudo-adhesive layer, and utilizing the resulting effect wherein the cationic resin electrically traps ink molecules, thereby fixing the ink molecules to the pseudo-adhesive layer, the fixability of inkjet inks can be improved.

Patent Document 3 targets the use of aqueous inks that use anionic inkjet dyes, and proposes the use of a weakly cationic polyimide-based resin in the pseudo-adhesive of a pseudo-adhesive paper, with the aim of preventing aggregation with the pseudo-adhesive, and enabling reliable fixing of anionic inkjet dyes.

Patent Documents 1 to 3 target the use of aqueous inks, and utilize the interaction between a cationic resin within the adhesive composition and the ink to improve the fixability. In those cases where a non-aqueous ink is used, which exhibits a much smaller electrical interaction with the resin in the adhesive composition than an aqueous ink, further improvements are still required.

Moreover, in Patent Document 1, including the polyallylamine hydrochloride in the adhesive composition causes a neutralization reaction with basic substances such as caustic soda contained within the natural rubber latex, resulting in precipitation of the latex rubber. This type of precipitated aggregate reduces the stability of the adhesive composition, resulting in a deterioration in the applicability of the adhesive composition to the sheet base material.
[Patent Document 1] JP 10-879 A
[Patent Document 2] JP 11-334201 A
[Patent Document 3] JP 9-71758 A

Accordingly, an object of the present invention is to achieve superior stability for a pseudo-pressure-sensitive adhesive composition, and to prevent the transfer of a printed image on a pressure-sensitive adhesive sheet coated with the pseudo-pressure-sensitive adhesive composition to a surface opposing the adhesive sheet.

### SUMMARY OF THE INVENTION

One aspect of the present invention proposes a pseudo-pressure-sensitive adhesive composition comprising an adhesive base, a filler and a polymer, wherein the polymer is a polyallylamine and/or a polydiallyldimethylammonium chloride with a weight-average molecular weight of less than 100,000.

Another aspect of the present invention provides a pressure-sensitive adhesive sheet on which is formed a layer comprising the above pseudo-pressure-sensitive adhesive composition.

Yet another aspect of the present invention provides a printing method, wherein printing is performed by inkjet printing onto a pressure-sensitive adhesive sheet on which is formed a layer comprising the pseudo-pressure-sensitive adhesive composition according to Claim 1, with the printing performed onto the layer comprising the pseudo-pressure-sensitive adhesive composition using a non-aqueous ink comprising a coloring material and a non-aqueous solvent.

### DETAILED DESCRIPTION OF THE EMBODIMENTS

A pseudo-pressure-sensitive adhesive composition according to one embodiment of the present invention comprises an adhesive base, a filler and a polymer, wherein the polymer is a polyallylamine and/or a polydiallyldimethylammonium chloride (hereafter sometimes abbreviated as poly-DADMAC) with a weight-average molecular weight of less than 100,000. This embodiment yields superior stability for the pseudo-pressure-sensitive adhesive composition, and can also prevent the transfer of a printed image on a pressure-sensitive adhesive sheet coated with the pseudo-pressure-sensitive adhesive composition to a surface opposing the adhesive sheet.

In the pseudo-pressure-sensitive adhesive compositions used in conventional pressure-sensitive adhesive sheets, if a cationic resin is added together with a natural rubber latex, then the composition can sometimes gel, making it impossible to apply the composition to the sheet. In contrast, in the pseudo-pressure-sensitive adhesive composition according to the present embodiment, by using the polymer described above, gelling of the adhesive base such as the natural rubber latex can be prevented, and the fixability of ink to the pressure-sensitive adhesive sheet can be enhanced.

Because the fixability of ink to the pressure-sensitive adhesive sheet is excellent, when printing is performed on the pressure-sensitive adhesive sheet, the sheet is pressure-bonded, and the bonded sheet is subsequently peeled apart, transfer of the ink to the opposing surface that was in contact with the printed portion can be prevented. In particular, even in those cases where a non-aqueous ink is used, which exhibits a smaller electrical interaction with the pseudo-pressure-sensitive adhesive composition than an aqueous ink, by using the polymer described above, the non-aqueous ink is able to be fixed securely to the pressure-sensitive adhesive sheet.

Further, even though the above polymer is added to the composition, the actions of the adhesive base and the filler can still be satisfactorily realized. The action of the adhesive base is to enhance the adhesiveness of the pressure-sensitive adhesive sheet to which the pseudo-pressure-sensitive adhesive composition has been applied. The actions of the filler include enhancing the releasability of the pressure-sensitive adhesive sheet to which the pseudo-pressure-sensitive adhesive composition has been applied, and increasing the image density.

For the polymer, a single polyallylamine or polydiallyldimethylammonium chloride with a weight-average molecular weight of less than 100,000 may be used alone, or a combination of two or more such polymers can be used.

The polyallylamine is a compound represented by the formula shown below.

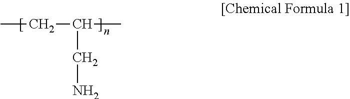

In the above formula, n represents a positive integer.

When the polymer is a polyallylamine, the pH of the pseudo-pressure-sensitive adhesive composition at 25° C. is preferably within a range from 9 to 12, and more preferably from 10 to 11. This ensures that when the polyallylamine is used in combination with the adhesive base, the formation of aggregates within the composition can be prevented regardless of the type of adhesive base that is used, thus providing excellent composition stability. Further, this composition stability can be maintained even when the polyallylamine is added in an amount, reported as a mass ratio relative to a value of 1 for the adhesive base, of 0.020 or greater, and this enables even better prevention of transfer of the printed image on the pressure-sensitive adhesive sheet coated with the pseudo-pressure-sensitive adhesive composition to the surface opposing the adhesive sheet.

The amount added of the polyallylamine, reported as a mass ratio relative to a value of 1 for the adhesive base, is preferably at least 0.020, more preferably 0.022 or greater, and more preferably 0.024 or greater. By adding the polyallylamine in an amount that satisfies this range, the fixability of ink to the pressure-sensitive adhesive sheet can be improved, and transfer of the printed image to the surface opposing the adhesive sheet can be better prevented.

Further, from the viewpoints of preventing any increase in viscosity and preventing the formation of aggregates, the amount of the polyallylamine, reported as a mass ratio relative to a value of 1 for the adhesive base, is preferably not more than 0.20, more preferably 0.10 or less, and still more preferably 0.080 or less.

The pH at 25° C. of a 5% by mass aqueous solution of the polyallylamine is preferably within a range from 9 to 12, and more preferably from 10 to 11. This ensures that when the polyallylamine is mixed with the adhesive base, the formation of aggregates can be prevented, and superior composition stability can be achieved.

The polyallylamine has a weight-average molecular weight that is preferably within a range from 1,000 to 6,000, and more preferably from 1,600 to 5,000. By ensuring a low weight-average molecular weight for the polyallylamine, any increase in the viscosity of the pseudo-pressure-sensitive adhesive composition can be prevented, enabling superior composition stability to be obtained, and the solubility of the polyallylamine can also be improved, which enables the preparation time for the pseudo-pressure-sensitive adhesive composition to be shortened. Furthermore, by ensuring that the weight-average molecular weight of the polyallylamine is at least 1,000, the strength of the applied coating layer can be improved.

The polydiallyldimethylammonium chloride has a weight-average molecular weight that is typically less than 100,000, preferably 50,000 or less, and more preferably 10,000 or less. By ensuring that the weight-average molecular weight is less than 100,000, the formation of aggregates can be prevented, and superior composition stability can be achieved.

On the other hand, from the viewpoint of ensuring favorable non-transferability, the weight-average molecular weight of the polydiallyldimethylammonium chloride is preferably at least 1,000.

The amount added of the polydiallyldimethylammonium chloride, reported as a mass ratio relative to a value of 1 for the adhesive base, is preferably at least 0.010, more preferably 0.015 or greater, and still more preferably 0.018 or greater. By adding the polydiallyldimethylammonium chloride in an amount that satisfies this range, the fixability of ink to the pressure-sensitive adhesive sheet can be improved, and transfer of the printed image to the surface opposing the adhesive sheet can be better prevented.

Further, from the viewpoints of preventing any increase in viscosity and preventing the formation of aggregates, the amount of the polydiallyldimethylammonium chloride, reported as a mass ratio relative to a value of 1 for the adhesive base, is preferably not more than 0.20, more preferably 0.11 or less, and still more preferably 0.080 or less.

The polydiallyldimethylammonium chloride may be used as a copolymer of a polydiallyldimethylammonium chloride and one or more of given monomers and oligomers. Preferably, one or more of a sulfo group and a amide group are introduced into main chain of the copolymer by using one or more compounds having one or more of a sulfo group and a amide group as the given monomers and/or oligomers. Examples of such copolymers include a polydiallyldimethylammonium chloride—sulfur dioxide copolymer or a polydiallyldimethylammonium chloride—acrylamide copolymer.

In those cases where a polyallylamine is combined with a poly-DADMAC having a weight-average molecular weight of less than 100,000 as the polymer, the amount of this combination, reported as a mass ratio relative to a value of 1 for the adhesive base, is preferably within a range from 0.010 to 0.20, more preferably from 0.010 to 0.10, and still more preferably from 0.020 to 0.080. Further, in this case, the polyallylamine and the poly-DADMAC may be combined with appropriate adjustment of the mass ratio between the two components.

The adhesive base may be any material that does not bond under normal conditions, but can be bonded by application of pressure, and natural rubbers, synthetic rubbers and synthetic resins and the like may be used. A natural rubber is preferable.

Examples of natural rubbers include natural rubber latexes containing a natural rubber as the main component, and modified latexes containing, as the main component, a modified rubber obtained by modifying a natural rubber, such as a grafted latex, acidic latex, depolymerized latex or vulcanized latex. Any one of these rubbers may be used individually, or a mixture containing two or more rubbers may be used. A natural rubber latex is particularly desirable.

The filler has the function of reducing the adhesiveness of the adhesive base and imparting the composition with releasability. Examples of the filler include silica, alumina, glass powder, starch (wheat starch), silas balloons, zeolites, calcium carbonate, zinc oxide, titanium oxide, kaolin and activated clay. Any of these fillers may be used individually, or a combination of a plurality of fillers may be used.

A silica filler is preferable, a silica having an oil absorption of 100 to 300 (ml/100 g) is more preferable, and a silica having an oil absorption of 130 to 250 (ml/100 g) is particularly desirable. The oil absorption can be determined in accordance with the JIS pigment test method (JIS 5101). By using this type of silica, a suitable level of adhesiveness is obtained, the non-aqueous ink solvent can be absorbed on the pressure-sensitive adhesive sheet, spreading of the ink dots can be prevented, and the image density can be improved.

The average particle size of the filler is preferably within a range from 1.0 to 20 μm, and more preferably from 4.0 to 15 μm.

The amount added of the filler, reported as a mass ratio relative to a value of 1 for the adhesive base, is typically within a range from 0.5 to 3.0, and preferably from 0.5 to 2.0. By using an amount of filler that satisfies this range, an appropriate peel strength can be obtained. By adding an appropriate amount of the filler, the pressure-sensitive adhesive sheet can be appropriately bonded and then peeled apart, penetration of the ink into the interior of the pressure-sensitive adhesive sheet can be prevented, and any deterioration in the image density can be prevented. On the other hand, if the filler is added in excess, then the adhesiveness may deteriorate too much, which is undesirable.

The pseudo-pressure-sensitive adhesive composition preferably uses an aqueous solvent medium, and the solvent is most preferably water. The use of a purified water containing minimal impurities, such as distilled water or ion-exchanged water, is preferable.

The pseudo-pressure-sensitive adhesive composition has a solid fraction that is preferably within a range from 5.0 to 60% by mass, and more preferably from 10 to 40% by mass.

In order to ensure stable dispersion of the filler and the like within the pseudo-pressure-sensitive adhesive composition, a conventional dispersant typified by polymeric dispersants and surfactants is preferably used.

Examples of commercially available polymeric dispersants include the Solsperse series of products manufactured by Lubrizol Japan Ltd. (Solsperse 20000, 27000, 41000, 41090, 43000 and 44000), the Joncryl series of products manufactured by Johnson Polymer, Inc. (Joncryl 57, 60, 62, 63, 71 and 501) and polyvinylpyrrolidone K-30 and K-90 manufactured by Dai-ichi Kogyo Seiyaku Co., Ltd.

Examples of the surfactant include anionic surfactants such as the Demol series of products manufactured by Kao Corporation (Demol N, RN, NL, RNL, T-45 and EP), and nonionic surfactants such as the Emulgen series of products manufactured by Kao Corporation (Emulgen A-60, A-90, A-500, B-40, L-40 and 420).

These dispersants may also be used in combinations containing a plurality of different dispersants.

The amount added of the dispersant need only be sufficient to ensure that the aforementioned filler and the like can be satisfactorily dispersed within the solvent, and may be set as appropriate.

In addition to the polymer described above, a water-soluble polymer may also be added to the pseudo-pressure-sensitive adhesive composition. This water-soluble polymer functions as a thickener. In order to achieve this function satisfactorily without impairing the effects of the present invention, the amount of the water-soluble polymer is preferably from 0.1 to 10% by mass relative to the total mass of the composition. Examples of polymers that can be used as the water-soluble polymer include natural polymers, semi-synthetic polymers and synthetic polymers.

Examples of natural polymers that can be used include plant-based natural polymers such as gum arabic, carageenan, guar gum, locust bean gum, pectin, tragacanth gum, corn starch, konjac mannan and agar; microbial natural polymers such as pullulan, xanthan gum and dextrin; and animal-based natural polymers such as gelatin, casein and animal glue.

Examples of semi-synthetic polymers that can be used include cellulose-based semi-synthetic polymers such as ethyl cellulose, carboxymethyl cellulose, hydroxyethyl cellulose, hydroxypropyl cellulose, methyl cellulose and hydroxypropyl methylcellulose; starch-based semi-synthetic polymers such as hydroxyethyl starch, sodium carboxymethyl starch and cyclodextrin; alginate-based semi-synthetic polymers such as sodium alginate and propylene glycol alginate; and sodium hyaluronate.

Examples of synthetic polymers that can be used include unsaturated carboxylic acid-based synthetic polymers such as poly(acrylic acid), poly(methacrylic acid), poly(crotonic acid), poly(itaconic acid), poly(maleic acid), acrylic acid-methacrylic acid copolymers, acrylic acid-itaconic acid copolymers, acrylic acid-maleic acid copolymers, acrylic acid-acrylamide copolymers, acrylic acid-acrylate ester copolymers, acrylic acid-methacrylate ester copolymers, acrylic acid-sulfonic acid-based monomer copolymers, acrylic acid-vinylpyrrolidone copolymers, and maleic anhydride-alkyl vinyl ether copolymers; vinyl-based synthetic polymers such as polyvinylpyrrolidone, polyvinyl alcohol, poly(vinyl methyl ether) and poly(N-vinylacetamide), as well as polyethylene oxide, polyethyleneimine and polyurethane.

These water-soluble polymers may be used individually, or in combinations containing two or more different polymers.

From the viewpoints of regulating the viscosity and retaining moisture, the pseudo-pressure-sensitive adhesive composition may also contain a water-soluble organic solvent. In order to ensure that the water-soluble organic solvent can achieve these functions without impairing the effects of the present invention, the amount of the water-soluble organic solvent is preferably within a range from 1.0 to 20% by mass relative to the total mass of the composition.

Examples of water-soluble organic solvents that can be used include glycols such as ethylene glycol, diethylene glycol, triethylene glycol, tetraethylene glycol, pentaethylene glycol, propylene glycol, dipropylene glycol and tripropylene glycol, glycerol, acetins, glycol derivatives such as triethylene glycol monomethyl ether, triethylene glycol monobutyl ether, tetraethylene glycol monomethyl ether, tetraethylene glycol dimethyl ether, tetraethylene glycol diethyl ether and tetraethylene glycol monobutyl ether, as well as triethanolamine, 1-methyl-2-pyrrolidone, β-thiodiglycol and sulfolane. These water-soluble organic solvents may be used individually, or in combinations containing two or more different polymers.

If necessary, the pseudo-pressure-sensitive adhesive composition may also include any of the various additives typically used in the technical field, provided addition of these additives does not impair the object of the present invention. Specific examples of additives that may be added include humectants (moisture retention agents), surface tension modifiers (surfactants), antifoaming agents, fixing agents, pH modifiers, antioxidants and preservatives.

The pseudo-pressure-sensitive adhesive composition according to the present embodiment can be prepared, for example, by combining all of the components including the adhesive base, the filler and the polymer, either in a single batch or in portions, and then dispersing the resulting mixture. Emulsions may be used for the adhesive base and the polymer.

Although there are no particular limitations on the viscosity of the pseudo-pressure-sensitive adhesive composition, the viscosity at 23° C. is typically adjusted to a value within a range from 10 to 150 mPa·s, and the viscosity is preferably from 10 to 100 mPa·s, and more preferably from 10 to 90 mPa·s. Here, the viscosity is measured at 23° C. by raising the shear stress from 0 Pa at a rate of 0.1 Pa/s, and refers to the measured value at 10 Pa.

A pressure-sensitive adhesive sheet according to one embodiment of the present invention is a pressure-sensitive adhesive sheet having a layer formed from the pseudo-pressure-sensitive adhesive composition described above. This pressure-sensitive adhesive sheet can prevent the transfer of a printed image to the surface opposing the adhesive sheet.

The pressure-sensitive adhesive sheet can be produced by a method that comprises applying the aforementioned pseudo-pressure-sensitive adhesive composition to a sheet base material, and subsequently drying the composition.

In order to enable the pressure-sensitive adhesive sheet to be folded over and bonded, or to enable two pressure-sensitive adhesive sheets to be bonded together, the pseudo-pressure-sensitive adhesive composition is applied to one or both of the opposing surfaces of the pressure-sensitive adhesive sheet. Further, in those cases where the pressure-sensitive adhesive sheet is folded in a Z-shape, the pseudo-pressure-sensitive adhesive composition can be applied to one or both surfaces of the opposing surfaces that exist in the folded state.

The method used for applying the pseudo-pressure-sensitive adhesive composition may involve applying the composition across the entire surface of the sheet base material using a brush, roller, bar coater, blade coater, die coater or roll coater or the like, or may employ a printing method such as inkjet printing or gravure printing.

The drying method may be any method that enables removal of the water and volatile components from the pseudo-pressure-sensitive adhesive composition, and drying may be performed for an arbitrary period with appropriate adjustment of the temperature and humidity.

The pseudo-pressure-sensitive adhesive composition is preferably applied to the sheet base material in an amount that yields a solid fraction of 1.0 to 15 g/m², and more preferably 1.0 to 10 g/m².

There are no particular limitations on the sheet base material of the pressure-sensitive adhesive sheet, and the sheet base material may be selected appropriately from among conventional materials such as plain paper, high-quality paper and matte paper. For example, because the pressure-sensitive adhesive sheet of the present embodiment is for use as a postcard, a sheet base material that is appropriate for a postcard can be used.

A printing method according to one embodiment of the present invention is a printing method in which printing is performed by inkjet printing on the layer comprising the pseudo-pressure-sensitive adhesive composition in the above pressure-sensitive adhesive sheet, using a non-aqueous ink comprising a coloring material and a non-aqueous solvent. This printing method can prevent the transfer of the printed image to the surface opposing the adhesive sheet.

An inkjet printer can be used for the inkjet printing performed in this embodiment. The inkjet printer may employ any of various printing systems, including a piezo system, electrostatic system or thermal system. In those cases where an inkjet printer is used, the ink of the present embodiment is preferably discharged from the inkjet head based on a digital signal, with the discharged ink droplets being adhered to the sensitive adhesive sheet.

The printed region of the pressure-sensitive adhesive sheet may be all or part of the layer comprising the pseudo-pressure-sensitive adhesive composition, or may be a plurality of locations within the layer.

One example of the method used for bonding the pressure-sensitive adhesive sheet comprises performing printing to the coated surface of the pressure-sensitive adhesive sheet, subsequently folding the sheet so that the coated surface faces inward, and then applying an arbitrary pressure from one side or both sides of the folded pressure-sensitive adhesive sheet to complete bonding. Following bonding, the bonded surfaces of the pressure-sensitive adhesive sheet can be peeled apart to reveal the printed surface.

According to the pressure-sensitive adhesive sheet of the present embodiment, a favorable level of adhesiveness can be obtained, with the peel strength of the bonded surfaces, for example 24 hours after bonding, typically exhibiting a peel strength in a T-type peel test (JIS K6854) of 40 to 100 (gf/25 mm).

The non-aqueous ink comprises a coloring material and a non-aqueous solvent, and may also contain other additives as required. A pigment, a dye, or a combination thereof may be used as the coloring material. The non-aqueous ink is an ink that contains substantially no water, and is preferably an ink with a water content of 5% by mass or less.

Examples of the pigment include organic pigments such as azo-based pigments, phthalocyanine-based pigments, dye-based pigments, condensed polycyclic pigments, nitro-based pigments and nitroso-based pigments (such as brilliant carmine 6B, lake red C, Watchung red, disazo yellow, Hansa yellow, phthalocyanine blue, phthalocyanine green, alkali blue and aniline black); inorganic pigments, including metals such as cobalt, iron, chromium, copper, zinc, lead, titanium, vanadium, manganese and nickel, as well as metal oxides and sulfides, and yellow ocher, ultramarine and iron blue pigments; and carbon blacks such as furnace carbon black, lamp black, acetylene black and channel black. Any one of these pigments may be used individually, or a combination of two or more different pigments may be used.

From the viewpoints of dispersibility and storage stability, the average particle size of the pigment is preferably not more than 300 nm, and more preferably 150 nm or less. In this description, the average particle size of the pigment refers to the value measured using a dynamic light-scattering particle size distribution measurement apparatus LB-500 manufactured by Horiba, Ltd.

The amount of the pigment within the ink is typically within a range from 0.01 to 20% by mass, and from the viewpoints of the print density and the ink viscosity, is preferably within a range from 3 to 15% by mass.

In those cases where a pigment is used, a pigment dispersant may also be added. There are no particular limitations on the pigment dispersant that is added, and any dispersant that enables the pigment to be dispersed stably within the solvent may be used. Examples of pigment dispersants that can be used favorably include hydroxyl group-containing carboxylate esters, salts of long-chain polyaminoamides and high-molecular weight acid esters, salts of high-molecular weight polycarboxylic acids, salts of long-chain polyaminoamides and polar acid esters, high-molecular weight unsaturated acid esters, high-molecular weight copolymers, modified polyurethanes, modified polyacrylates, polyether ester anionic surfactants, naphthalenesulfonic acid-formalin condensate salts, polyoxyethylene alkyl phosphate esters, polyoxyethylene nonyl phenyl ethers, polyester polyamines, and stearyl amine acetate. Among these, the use of a polymeric dispersant is preferable. These pigment dispersants may be used individually, or in combinations of two or more compounds.

The amount of the pigment dispersant within the ink may be determined as appropriate, but from the viewpoint of pigment dispersibility, the amount of the dispersant is preferably within a range from approximately 0.05 to 1.0 parts by mass, and more preferably from 0.1 to 0.7 parts by mass, per 1 part by mass of the pigment. Relative to the total mass of the ink, the pigment dispersant is preferably included in an amount of approximately 0.5 to 10% by mass, and more preferably 1 to 5% by mass.

Examples of dyes that can be used include oil-soluble dyes such as azo-based dyes, anthraquinone-based dyes and azine-based dyes. These dyes may be used individually, or a combination of two or more different dyes may be used.

The term “non-aqueous solvent” refers to non-polar organic solvents and polar organic solvents for which the 50% distillation point is at least 150° C. The “50% distillation point” is measured in accordance with JIS K0066 “Test Methods for Distillation of Chemical Products” and refers to the temperature at which 50% by mass of the solvent is evaporated.

For example, examples of preferred non-polar organic solvents include aliphatic hydrocarbon solvents, alicyclic hydrocarbon solvents and aromatic hydrocarbon solvents. Specific examples of preferred aliphatic hydrocarbon solvents and alicyclic hydrocarbon solvents include Teclean N-16, Teclean N-20, Teclean N-22, Nisseki Naphtesol L, Nisseki Naphtesol M, Nisseki Naphtesol H, No. 0 Solvent L, No. 0 Solvent M, No. 0 Solvent H, Nisseki Isosol 300, Nisseki Isosol 400, AF-4, AF-5, AF-6 and AF-7, all manufactured by JX Nippon Oil & Energy Corporation; and Isopar G, Isopar H, Isopar L, Isopar M, Exxsol D40, Exxsol D80, Exxsol D100, Exxsol D130 and Exxsol D140, all manufactured by Exxon Mobil Corporation. Specific examples of preferred aromatic hydrocarbon solvents include Nisseki Cleansol G (alkylbenzene) manufactured by TX Nippon Oil & Energy Corporation, and Solvesso 200 manufactured by Exxon Mobil Corporation.

Examples of solvents that can be used as the polar organic solvent include ester-based solvents, alcohol-based solvents, higher fatty acid-based solvents, ether-based solvents, and mixtures thereof. Examples of preferred polar organic solvents include one or more solvents selected from the group consisting of ester-based solvents that are esters of a higher fatty acid of 8 to 20 carbon atoms and an alcohol of 1 to 24 carbon atoms, higher alcohols of 8 to 24 carbon atoms, and higher fatty acids of 8 to 20 carbon atoms.

More specific examples of polar organic solvents that can be used favorably include ester-based solvents such as methyl laurate, isopropyl laurate, isopropyl myristate, isopropyl palmitate, isostearyl palmitate, methyl oleate, ethyl oleate, isopropyl oleate, butyl oleate, methyl linoleate, isobutyl linoleate, ethyl linoleate, isopropyl isostearate, methyl soybean oil, isobutyl soybean oil, methyl tallate, isobutyl tallate, diisopropyl adipate, diisopropyl sebacate, diethyl sebacate, propylene glycol monocaprate, trimethylolpropane tri-2-ethylhexanoate and glyceryl tri-2-ethylhexanoate; alcohol-based solvents such as isomyristyl alcohol, isopalmityl alcohol, isostearyl alcohol, oleyl alcohol, hexyldecanol, octyldodecanol and decyltetradecanol; higher fatty acid-based solvents such as nonanoic acid, isononanoic acid, isomyristic acid, hexadecanoic acid, isopalmitic acid, oleic acid and isostearic acid; and ether-based solvents such as diethylene glycol monobutyl ether, ethylene glycol monobutyl ether, propylene glycol monobutyl ether and propylene glycol dibutyl ether.

In addition to the components described above, the ink may also include various additives. Specifically, anionic surfactants, cationic surfactants, amphoteric surfactants, nonionic surfactants, or polymer-based, silicone-based or fluorine-based surfactants can be added to the ink as antifoaming agents or surface tension depressants.

The non-aqueous ink can be prepared, for example, by dispersing all of the components, either in a single batch or in portions, in a dispersion device such as a beads mill, and if desired, filtering the resulting dispersion through a filtration device such as a membrane filter. In one specific example, the non-aqueous ink can be produced by preparing a mixture in advance by uniformly mixing a portion of the non-aqueous solvent and all of the coloring material, dispersing the mixture in a dispersion device, subsequently adding the remaining components to the dispersion, and then passing the resulting mixture through a filtration device.

When using the non-aqueous ink in an inkjet printing system, the ideal range for the viscosity of the non-aqueous ink will vary depending on factors such as the diameter of the discharge head nozzles and the discharge environment, but generally, at 23° C., the viscosity is preferably within a range from 5 to 30 mPa·s, more preferably from 5 to 15 mPa·s, and is most preferably approximately 10 mPa·s. The viscosity is measured at 23° C. by raising the shear stress from 0 Pa at a rate of 0.1 Pa/s, and refers to the measured value at 10 Pa.

The present invention is able to achieve superior stability for a pseudo-pressure-sensitive adhesive composition, and can also prevent the transfer of a printed image on a pressure-sensitive adhesive sheet coated with the pseudo-pressure-sensitive adhesive composition to a surface opposing the adhesive sheet.

### EXAMPLES

The present invention is described below in further detail using a series of examples, but the present invention is in no way limited by these examples. In the following description, the units “%” represent “% by mass”.

### (Preparation of Pseudo-Pressure-Sensitive Adhesive Compositions)

Formulations of pseudo-pressure-sensitive adhesive compositions of a series of examples and comparative examples are shown in Table 1 and Table 2. The components shown in Table 1 and Table 2 were mixed in the proportions shown to prepare each of the pseudo-pressure-sensitive adhesive compositions.

The pH at 25° C. of each of the obtained compositions was measured using a Compact pH Meter B-212 manufactured by Horiba, Ltd. Further, the mass ratio of silica relative to a value of 1 for the natural rubber latex, and the mass ratio of the polymer component (here, the term “polymer component” describes the polyallylamine, polyallylamine hydrochloride, poly-DADMAC, and polyamide-epichlorohydrin) relative to a value of 1 for the natural rubber latex were also determined. The results are also shown in Table 1 and Table 2.

TABLE 1
Pseudo-pressure-sensitive adhesive compositions of examples:
formulations and evaluation results

| Units: % by mass | Example | | | | | | | |
|---|---|---|---|---|---|---|---|---|
| Calculated as solid fraction | 1 | 2 | 3 | 4 | 5 | 6 | 7 | 8 |
| Silica A | 9.77 | 9.77 | 9.77 | — | 10.00 | 10.00 | 10.00 | 10.00 |
| Silica B | — | — | — | 9.77 | — | — | — | — |
| Natural rubber latex | 6.16 | 6.16 | 6.16 | 6.16 | 12.42 | 12.42 | 12.42 | 12.42 |
| Polyallylamine A | 0.15 | — | — | 0.15 | — | — | — | — |
| Polyallylamine B | — | 0.15 | — | — | — | — | — | — |
| Polyallylamine C | — | — | 0.15 | — | — | — | — | — |
| poly-DADMAC (A) | — | — | — | — | 0.82 | 1.40 | 0.23 | — |
| poly-DADMAC (C) | — | — | — | — | — | — | — | 0.82 |
| Polyvinyl alcohol | 3.26 | 3.26 | 3.26 | 3.26 | 3.33 | 3.33 | 3.33 | 3.33 |
| Dispersant | 0.73 | 0.73 | 0.73 | 0.73 | 0.75 | 0.75 | 0.75 | 0.75 |
| Starch | 6.51 | 6.51 | 6.51 | 6.51 | 6.67 | 6.67 | 6.67 | 6.57 |
| Pure water | 73.42 | 73.37 | 73.37 | 73.40 | 66.01 | 65.43 | 66.60 | 66.01 |
| Total (% by mass) | 100.0 | 100.0 | 100.0 | 100.0 | 100.0 | 100.0 | 100.0 | 100.0 |
| Composition pH at 25° C. | 10.5 | 10.8 | 10.7 | 10.7 | 9.8 | 9.7 | 9.9 | 6.5 |
| Mass of silica relative to a value of 1 | 1.59 | 1.59 | 1.59 | 1.59 | 0.81 | 0.81 | 0.81 | 0.81 |
| for natural rubber latex (mass ratio) | | | | | | | | |
| Mass of polymer component relative | 0.024 | 0.024 | 0.024 | 0.024 | 0.066 | 0.11 | 0.019 | 0.066 |
| to a value of 1 for natural rubber latex | | | | | | | | |
| (mass ratio) | | | | | | | | |
| Composition stability | A | A | A | A | A | B | A | A |
| Non-transferability | A | A | A | A | A | A | A | A |
| Adhesiveness | A | A | A | A | A | A | A | A |
| Image density | A | A | A | A | A | A | A | A |

TABLE 2
Pseudo-pressure-sensitive adhesive compositions of comparative
examples: formulations and evaluation results

| Units: % by mass | Comparative Example | | | | | | |
|---|---|---|---|---|---|---|---|
| Calculated as solid fraction | 1 | 2 | 3 | 4 | 5 | 6 | 7 |
| Silica A | — | 11.03 | 9.87 | — | 9.77 | 10.00 | 10.00 |
| Silica B | — | — | — | 9.77 | — | — | — |
| Natural rubber latex | 6.82 | — | 6.22 | 6.16 | 6.16 | 12.42 | 12.42 |
| Polyallylamine A | 0.16 | 0.17 | — | — | — | — | — |
| Polyallylamine hydrochloride A | — | — | — | 0.39 | — | — | — |
| Polyallylamine hydrochloride B | — | — | — | — | 0.39 | — | — |
| poly-DADMAC (B) | — | — | — | — | — | 0.82 | — |
| Polyamide-epichlorohydrin | — | — | — | — | — | — | 0.82 |
| Polyvinyl alcohol | 3.61 | 3.68 | 3.29 | 3.26 | 3.26 | 3.33 | 3.33 |
| Dispersant | 0.81 | 0.83 | 0.74 | 0.73 | 0.73 | 0.75 | 0.75 |
| Starch | 7.22 | 7.35 | 6.58 | 6.51 | 6.51 | 6.67 | 6.67 |
| Pure water | 81.38 | 76.95 | 73.31 | 73.18 | 73.18 | 65.99 | 65.99 |
| Total (% by mass) | 100.0 | 100.0 | 100.0 | 100.0 | 100.0 | 100.0 | 100.0 |
| Composition pH at 25° C. | 11.3 | 5.8 | 9.3 | 9.4 | 9.3 | 9.7 | 6.5 |
| Mass of silica relative to a value of 1 | 0 | — | 1.56 | 1.56 | 1.56 | 0.81 | 0.81 |
| for natural rubber latex (mass ratio) | | | | | | | |
| Mass of polymer component relative | 0.023 | — | 0 | 0.063 | 0.063 | 0.066 | 0.066 |
| to a value of 1 for natural rubber latex | | | | | | | |
| (mass ratio) | | | | | | | |
| Composition stability | A | A | A | C | C | C | C |
| Non-transferability | B | — | B | — | — | — | — |
| Adhesiveness | B-1 | B-2 | A | — | — | B-1 | — |
| Image density | D | — | A | — | — | — | — |

The components shown in Table 1 and Table 2 were as follows.

Silica A: “Gel-type Silica BS-510J”, oil absorption 250 (ml/100 g), manufactured by Evonik Degussa Japan Co., Ltd.

Silica B: “Precipitated-type Silica P-527”, oil absorption 130 (ml/100 g), manufactured by Mizusawa Industrial Chemicals, Ltd.

Natural rubber latex: “Saivinol E”, solid fraction 54%, manufactured by Saiden Chemical Industry Co., Ltd.

Polyallylamine A: “PAA-01”, an aqueous solution with a solid fraction of 15%, pH 10 to 11, weight-average molecular weight (Mw) 1,600, manufactured by Nittobo Medical Co., Ltd.

Polyallylamine B: “PAA-03”, an aqueous solution with a solid fraction of 20%, pH 10 to 11, weight-average molecular weight (Mw) 3,000, manufactured by Nittobo Medical Co., Ltd.

Polyallylamine C: “PAA-05”, an aqueous solution with a solid fraction of 20%, pH 10 to 11, weight-average molecular weight (Mw) 5,000, manufactured by Nittobo Medical Co., Ltd.

Polyallylamine hydrochloride A: “PAA-HCL-03”, an aqueous solution with a solid fraction of 40%, pH 2 to 3, weight-average molecular weight (Mw) 3,000, manufactured by Nittobo Medical Co., Ltd.

Polyallylamine hydrochloride B: “PAA-HCL-05”, an aqueous solution with a solid fraction of 40%, pH 2 to 3, weight-average molecular weight (Mw) 5,000, manufactured by Nittobo Medical Co., Ltd.

poly-DADMAC (A): Polydiallyldimethylammonium chloride, “Unisence FPA101L”, solid fraction 35%, pH 6.0, weight-average molecular weight (Mw) less than 100,000, manufactured by Senka Corporation.

poly-DADMAC (B): Polydiallyldimethylammonium chloride, “Unisence FPA1002L”, solid fraction 18%, pH 7.0, weight-average molecular weight (Mw) at least 500,000, manufactured by Senka Corporation.

Poly-DADMAC(C): Polydiallyldimethylammonium chloride—sulfur dioxide copolymer, “PAS-A-1”, solid fraction 24%, pH 2.0 to 4.0, weight-average molecular weight (Mw) 5,000, manufactured by Nittobo Medical Co., Ltd.

Polyamide-epichlorohydrin: “WS-4020”, solid fraction 25%, pH 3.5, manufactured by Seiko PMC Corporation.

Polyvinyl alcohol: “JMR-10M”, manufactured by Japan VAM & POVAL Co., Ltd.

Dispersant: “Demol EP”, solid fraction 25%, manufactured by Kao Corporation.

Starch: wheat starch, manufactured by Wako Pure Chemical Industries, Ltd.

The pH values of the above polymer components were measured at 25° C. for a 5% by mass aqueous solution, using a Compact pH Meter B-212 manufactured by Horiba, Ltd.

### (Evaluations)

Next, the pseudo-pressure-sensitive adhesive composition of each example and each comparative example was evaluated for composition stability, non-transferability, adhesiveness, and image density. The results of these evaluations are also shown in Table 1 and Table 2.

### < Preparation of Pressure-Sensitive Adhesive Sheets>

Using a bar coater, the pseudo-pressure-sensitive adhesive composition of each example and each comparative example was applied to one surface of a 210 cm×297 cm sheet of plain paper (Riso Paper IJ, weight 60 g/m², manufactured by Riso Kagaku Corporation), the paper was then subjected to room-temperature drying at a temperature of 23° C. and a humidity of 50%, and then left to stand for 24 hours to complete preparation of a pressure-sensitive adhesive sheet. The composition was applied in an amount that yielded a dried weight of 6 g/m².

### < Composition Stability>

Twenty four hours after preparation, the pseudo-pressure-sensitive adhesive composition of each example and each comparative example was inspected visually for the presence of aggregates within the composition, and the viscosity was also measured. An evaluation was then performed against the criteria listed below. In the case of the following evaluation criteria A and B, the composition was able to be applied to the sheet, but in the case of the evaluation criterion C, the composition was unable to be applied to the sheet.

The ink viscosity refers to the viscosity at 10 Pa when the shear stress was raised from 0 Pa at a rate of 0.1 Pa/s and at a temperature of 23° C., and was measured using a Rheometer AR-G2, manufactured by TA Instruments, Japan Inc. (cone angle: 2°, diameter 40 mm).

A: no aggregates in the composition. Viscosity of the composition at 23° C. was less than 95 mPa·s.

B: no aggregates in the composition. Viscosity of the composition at 23° C. was at least 95 mPa·s.

C: aggregates in the composition.

### < Non-Transferability>

Printing was performed on the coated surface of each of the pressure-sensitive adhesive sheets coated with the pseudo-pressure-sensitive adhesive composition of each example and each comparative example. The printing was performed by installing an inkjet ink (RISO X ink, F series, manufactured by Riso Kagaku Corporation) in an inkjet printer (Orphis X9050, manufactured by Riso Kagaku Corporation), and then printing a solid black image of 2 cm×2 cm at a resolution of 300×300 dpi and using a discharge volume of 18 pl onto the coated surface of the pressure-sensitive adhesive sheet, thus forming a printed item.

Following printing, a mail sealer (PRESSLE multi II, manufactured by Toppan Forms Co., Ltd.) was used to fold the obtained printed item with the coated surface facing inward, so that the printed portion opposed a non-printed portion, pressure bonding was performed with a roll gap of 16, and the sealed product was then left to stand for 24 hours in an environment at a temperature of 23° C. and a humidity of 50%.

Subsequently, the pressure-sensitive adhesive sheet was peeled apart, and the image density of the surface that opposed the printed portion, and the image density of a non-printed region of the coated surface were measured numerically using an i1i0 device manufactured by X-Rite, Inc. Based on the difference between the image density of the surface that opposed the printed portion, and the image density of a non-printed region of the coated surface (ΔO.D. value), the non-transferability was evaluated against the following criteria.

A: ΔO.D. value of less than 0.06

B: ΔO.D. value of at least 0.06

### < Adhesiveness>

The pressure-sensitive adhesive sheets coated with the pseudo-pressure-sensitive adhesive composition of each example and each comparative example were cut into test pieces having a width of 25 mm and a length of 100 mm. Using a mail sealer (PRESSLE multi II, manufactured by Toppan Forms Co., Ltd.), the test piece of each pressure-sensitive adhesive sheet was folded with the coated surface facing inward, and pressure bonding was performed with a roll gap of 16. After standing for 24 hours, a T-type peel test (JIS K6854) was performed, and based on the measured value, the adhesiveness was evaluated against the criteria listed below. In the case of the evaluation criterion B-1, the peel strength was high, and peeling of the pressure-sensitive adhesive sheet was difficult. In the case of the evaluation criterion B-2, the peel strength was low, and the pressure-bonding of the pressure-sensitive adhesive sheet was unsatisfactory.

A: 40 to 100 (gf/125 mm)

B-1: 100 to 300 (gf/25 mm)

B-2: less than 40 (gf/25 mm)

### < Image Density>

A printed item was obtained using the same method as that described above for the non-transferability evaluation. The image density (O.D. value) of the printed portion of the obtained printed item was measured using an i1i0 device manufactured by X-Rite, Inc., and the measured value was evaluated against the following criteria.

A: O.D. value of at least 0.70

B: O.D. value of at least 0.60 but less than 0.70

C: O.D. value of less than 0.60

D: measurement impossible (the ink was not absorbed by the sheet, making measurement of the image density impossible)

As shown in Table 1 and Table 2, in each of the examples, the composition stability, adhesiveness, non-transferability and image density were all favorable.

In Comparative Example 1, no silica was added, and the peel strength was high and the releasability was poor. Further, absorption of the ink also deteriorated and the non-transferability was poor, meaning the image density could not be measured. In Comparative Example 2, no latex was added, and the peel strength was inadequate and the pressure-sensitive adhesive sheet could not be bonded. In Comparative Example 3, no polyallylamine or poly-DADMAC having a weight-average molecular weight of less than 100,000 was added, and the ink non-transferability deteriorated. In Comparative Examples 4, 5 and 7, the composition contained a polyallylamine hydrochloride or a polyamide-epichlorohydrin, and in each case the composition stability deteriorated, making application of the composition impossible. In Comparative Example 6, the weight-average average molecular weight of the poly-DADMAC was greater than 100,000, and the composition stability deteriorated, making application of the composition impossible.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A pseudo-pressure-sensitive adhesive composition comprising an adhesive base, a filler and a polymer, wherein the polymer is a polyallylamine and/or a polydiallyldimethylammonium chloride with a weight-average molecular weight of less than 100,000.

2. The pseudo-pressure-sensitive adhesive composition according to claim 1, wherein a pH at 25° C. of a 5% by mass aqueous solution of the polyallylamine is within a range from 9 to 12.

3. The pseudo-pressure-sensitive adhesive composition according to claim 1, wherein the polyallylamine has a weight-average molecular weight of 1,000 to 6,000.

4. The pseudo-pressure-sensitive adhesive composition according to claim 1, wherein an amount of the polyallylamine, reported as a mass ratio relative to a value of 1 for the adhesive base, is within a range from 0.020 to 0.20.

5. The pseudo-pressure-sensitive adhesive composition according to claim 1, wherein an amount of the polydiallyldimethylammonium chloride, reported as a mass ratio relative to a value of 1 for the adhesive base, is within a range from 0.010 to 0.20.

6. The pseudo-pressure-sensitive adhesive composition according to claim 1, wherein the filler is a silica having an oil absorption of 100 to 300 (ml/100 g).

7. The pseudo-pressure-sensitive adhesive composition according to claim 1, wherein the adhesive base is a natural rubber.

8. A pressure-sensitive adhesive sheet, on which is formed a layer comprising the pseudo-pressure-sensitive adhesive composition according to claim 1.

9. A printing method, wherein printing is performed by inkjet printing onto a pressure-sensitive adhesive sheet on which is formed a layer comprising the pseudo-pressure-sensitive adhesive composition according to claim 1, with the printing performed onto the layer comprising the pseudo-pressure-sensitive adhesive composition using a non-aqueous ink comprising a coloring material and a non-aqueous solvent.
